(19) United States
(12) Patent Application Publication
(10) Pub. No.: US 2002/0076255 A1
(43) Pub. Date: Jun. 20, 2002

(54) Skin disinfectant applicator

(76) Inventors: Minh Q. Hoang, Taylorsville, UT (US); Jonathan K. Burkholz, Salt Lake City, UT (US)

Correspondence Address: RICHARD J. RODRICK, ESQ., BECTON, DICKINSON AND COMPANY, 1 BECTON DRIVE, FRANKLIN LAKES, NJ, 07417, US

(21) Appl. No.: 09/741,516

(22) Filed: Dec. 20, 2000

(51) Int. Cl. B43K 5/14

(52) U.S. Cl. 401/133; 401/6; 401/196

(57) ABSTRACT

The applicator for an anti-microbial prep solution of this invention includes a generally hollow handle having a closed proximal end and an open distal end, a foam pad attached to the hollow handle over the open distal end, an ampoule that holds the anti-microbial solution therein and a means for opening the ampoule.

### BACKGROUND OF THE INVENTION

This invention relates to an applicator that can be used by a healthcare professional to apply an anti-microbial prep solution, such as an alcohol-based solution, to a patient's skin. Such an anti-microbial prep solution can be used for IV and surgical site preparation and as a general skin disinfectant.

Because microorganisms lie on the skin, standard invasive medical procedures require the patient's skin where the procedure is to take place to be disinfected prior to the procedure. This skin preparation is important in order to minimize the risk of infection to the patient.

Alcohol has long been recognized as a fast acting broad-spectrum disinfectant. Alcohol-based solutions have many advantages over soap or water based antiseptic solutions, such as reduced prepping and solution drying time. However, alcohol is flammable and its use and application on a patient must be carefully controlled in order to minimize the fire hazard created when an alcohol disinfecting solution is used. Indeed, in its January 1992 Guidance on Surgical Fires, the ECRI stated that approximately ten surgical patient fires come to its attention per year. Most of these fires ignite on or in the patient and obviously can cause considerable injury to the patient. The ECRI estimate that this problem is more severe than the numbers would indicate because it believes that numerous other unreported fires occur. This problem is exacerbated today since today's surgical suites and other patient care facilities include a significant number of electrical equipment that may come in contact with the patient. For example, such electrical equipment includes patient monitoring devices, electrosurgical or electrocautery devices, defibrillators, heated probes, drills, burs, argon beam coagulators, fiberoptic light sources and cables and lasers, which all may be used on and around the patient. In addition, the atmosphere in surgical suites and other patient care facilities is made more combustible because of the common use of oxygen there.

Many different types of anti-microbial applicators exist but could be improved. Some applicators allow the anti-microbial solution to flow therefrom in large uncontrolled amounts. Other applicators do not have a mechanism to shut off the flow of the anti-microbial solution once the flow starts so that all of the anti-microbial solution must be dispensed from the applicator. Both of these types of applicators are problematic because they may allow excessive amounts of the anti-microbial solution to flow onto the patient where it could pool and create a significant fire hazard if the anti-microbial solution is flammable. In addition, a patient is often covered by a surgical cloth drape after prepping, i.e. the disinfecting procedure, takes place. Where a significant amount of the anti-microbial solution is placed on a patient, the surgical drape can collect the vapors from the anti-microbial solution as the excess anti-microbial solution vaporizes. Again, if the anti-microbial solution is flammable a potential exists for a severe accident to the patient and the healthcare professionals in the area. Also, this inability to adequately control the flow of anti-microbial solution on and around the patient increases the likelihood that the solution will stain material in the area.

Anti-microbial applicators are often supplied in a surgical prep kit. These kits are often sterilized after assembly. Typically, sterilization is achieved by irradiating the kit with gamma radiation or exposing the kit to ethylene-oxide (ETO) gas. Therefore these applicators must be designed to withstand the rigors of such sterilization procedures so that the functionality of the applicators are not affected and the efficacy and stability of the anti-microbial solution are not affected. For example, the use of gamma radiation may cause various parts of the applicator to degrade and may cause the anti-microbial solution to breakdown into unwanted materials. Where ETO sterilization is used, the ETO gas could be absorbed by the anti-microbial solution, which could make it toxic to humans. To avoid the adverse affects of ETO sterilization, the anti-microbial solution is typically placed in a glass ampoule located in the handle of the applicator. The glass ampoule is a self-contained unit. Therefore a means for opening the glass ampoule must be provided in the applicator. The applicators that are currently available have such means for opening the glass ampoule but they could be improved. For example, the means for opening the glass ampoule currently used require the clinician to exert an uncomfortably high force on the handle to break the glass ampoule. In addition, some of these means are difficult to use or are not intuitive to use.

### SUMMARY OF THE INVENTION

It is therefore an object of the invention to provide an applicator for an anti-microbial prep solution that is not adversely affected by the sterilization process and that protects the anti-microbial prep solution in the applicator from being adversely affected.

It is another object of this invention to provide an applicator that does not require the clinician to exert an uncomfortably high force to the applicator to cause the anti-microbial prep solution to flow from the applicator.

The applicator for an anti-microbial prep solution of this invention includes a generally hollow handle having a closed proximal end and an open distal end, a foam pad attached to the hollow handle over the open distal end, an ampoule that holds the anti-microbial prep solution therein and a means for opening the ampoule. If desired, a flow control valve that controls the flow of the anti-microbial prep solution from the applicator handle to the foam pad is provided in the applicator. Preferably, the ampoule includes a frangible portion that cooperates with the means for opening the ampoule so that the frangible portion can be broken by the means for opening the ampoule to allow the anti-microbial solution to flow out of the ampoule. The means for opening the ampoule can take many forms. For example, a lever located on the hollow handle can be pivoted toward the body of the hollow handle such that a portion of the lever contacts and breaks the frangible portion of the ampoule. Alternatively, a portion of the hollow handle can be squeezed by the clinician to contact and break the ampoule. Another means includes a movable button located on the hollow handle can be moved into contact with the ampoule to thereby break and open the ampoule.

### BRIEF DESCRIPTION OF THE DRAWINGS

The preferred embodiments are illustrated in the drawings in which like reference numerals refer to like elements and in which:

FIG. 1 is an exploded perspective view of a first embodiment of the applicator of this invention;

FIG. 2 is a perspective view of the first embodiment of the applicator of this invention;

FIG. 3 is a side elevation view in cross section of the first embodiment of the applicator of this invention taken along line 3-3 of FIG. 2 prior to release of the anti-microbial solution from the ampoule contained in the applicator;

FIG. 4 is a side elevation view in cross section of the first embodiment of the applicator of this invention similar to FIG. 3 but after release of the anti-microbial solution from the ampoule contained in the applicator;

FIG. 5 is a side elevation view in cross section of the first embodiment of the applicator of this invention similar to FIG. 4 but showing the applicator being pressed on a surface such as a patient's skin;

FIG. 6 is a side elevation view in cross section of a second embodiment of the applicator of this invention prior to release of the anti-microbial solution from the ampoule contained in the applicator;

FIG. 7 is a side elevation view in cross section of the second embodiment of the applicator of this invention after release of the anti-microbial solution from the ampoule contained in the applicator;

FIG. 8 is a side elevation view in cross section of a third embodiment of the applicator of this invention prior to release of the anti-microbial solution from the ampoule contained in the applicator;

FIG. 9 is a side elevation view in cross section of the third embodiment of the applicator of this invention after release of the anti-microbial solution from the ampoule contained in the applicator;

FIG. 10 is a top plan view of a fourth embodiment of the applicator of this invention prior to release of the anti-microbial solution from the ampoule contained in the applicator;

FIG. 11 is a top plan view of the fourth embodiment of the applicator of this invention after release of the anti-microbial solution from the ampoule contained in the applicator;

FIG. 12 is an end elevation view of one version of the lever of the fourth embodiment of the applicator of this invention;

FIG. 13 is an end elevation view of another version of the lever of the fourth embodiment of the applicator of this invention;

FIG. 14 is an exploded side elevation view, partially in cross section, of a fifth embodiment of the applicator of this invention;

FIG. 15 is a side cross sectional view of the fifth embodiment of the applicator of this invention prior to release of the anti-microbial solution from the ampoule contained in the applicator;

FIG. 16 is a cross sectional view of a portion of the fifth embodiment of the applicator of this invention taken along line 16-16 of FIG. 15 prior to release of the anti-microbial solution from the ampoule contained in the applicator; and

FIG. 17 is a cross sectional view of a portion of the fifth embodiment of the applicator of this invention similar to FIG. 16 but after release of the anti-microbial solution from the ampoule contained in the applicator.

### DETAILED DESCRIPTION OF THE INVENTION

As used herein, the term “proximal” refers to a location on the applicator for an anti-microbial solution of this invention that, during normal use, is closest to the clinician using the device and farthest from the patient in connection with whom the device is used. Conversely, the term “distal” refers to a location on the applicator of this invention that, during normal use, is farthest from the clinician using the device and closest to the patient in connection with whom the device is used.

As used herein, the term “top”, “up” or “upwardly” refers to a location on the applicator for an anti-microbial solution of this invention that, during normal use, is radially away from the device and away from the patient's skin. Conversely, as used herein, the term “bottom”, “down” or “downwardly” refers to a location on the applicator of this invention that, during normal use, is radially away from the device and toward the patient's skin.

As used herein, the term “in” or “inwardly” refers to a location with respect to the applicator for an anti-microbial solution of this invention that, during normal use, is toward the inside of the device. Conversely, as used herein, the term “out” or “outwardly” refers to a location with respect to the applicator of this invention that, during normal use, is toward the outside of the device.

Although the applicator of this invention is described for use with an alcohol-based anti-microbial prep solution, it is to be understood that any liquid anti-microbial solution may be used with the applicator.

The applicator 10 for an anti-microbial solution of this invention includes a generally hollow handle 20 having a closed proximal end and an open distal end and a foam pad 30 attached to hollow handle 20 over the open distal end. If desired a flow control valve may be associated with foam pad 30. The flow control valve controls the flow of the anti-microbial solution from hollow handle 20 to foam pad 30 and then to the patient. The flow control valve may be a slit 40 formed in foam pad 30. Slit 40 is designed so that it remains closed when no pressure is exerted on the distal surface of foam pad 30. However, when pressure is exerted on the distal surface of foam pad 30, such as when applicator 10 is pressed against a patient's skin, slit 40 opens to allow the anti-microbial solution to flow past slit 40 into foam pad 30. There the anti-microbial solution can be easily distributed over the patient's skin by foam pad 30. When a sufficient amount of the anti-microbial solution has flowed into foam pad 30, the clinician can release the pressure exerted on the distal surface of foam pad 30 to stop the flow of anti-microbial solution out of hollow handle 20. See our co-pending patent application, U.S. application serial No. (P-5102) for a disclosure of various embodiments for slit 40.

Foam pad 30 is attached to hollow handle 20 over its open distal end by adhesive, flame bonding or any other suitable means. Preferably, the longitudinal axis of foam pad 30 is oriented at about 45 degrees to the longitudinal axis of the distal portion of hollow handle 20 although an angle between 30 degrees and 60 degrees is acceptable.

Hollow handle 20 can take any configuration desired. However, preferably it has a generally tubular, dog-leg configuration where the angle is about 15 degrees although an angle up to about 30 degrees is acceptable. Hollow handle 20 may be over-molded with a soft material that is easily gripped and more comfortable to the clinician, such as polyisoprene or the like. Preferably, hollow handle 20 is formed from a transparent or translucent polymer, such as low, medium or high density polyethylene, PET or the like. Since most prep solutions are colored with a dye or naturally are brown, such as iodine, this feature will allow the clinician to easily determine the amount of anti-microbial solution remaining in hollow handle 20.

The open proximal end of hollow handle 20 is sealed with a plug 21 that may be press fit or screw fit therein. A port may be formed in plug 21 to allow air to flow into hollow handle 20 as the anti-microbial solution flows out of hollow handle 20.

Hollow handle 20 holds an ampoule 25 therein that contains the anti-microbial solution therein. Ampoule 25 is designed to contain between about 5 ml and about 50 ml of the anti-microbial solution. Preferably ampoule 25 is located in the proximal portion of hollow handle 20 and is held firmly in place by ribs that may be formed on the inside of hollow handle 20. These ribs preferably extend longitudinally and parallel to the longitudinal axis of the proximal portion of hollow handle 20. Ampoule 25 can be formed from any standard ampoule glass commercially available such as the ampoule glass that can be obtained from Kimball Glass or BD Accuglass. Preferably, ampoule 25 has a frangible portion adjacent to its distal end, which allows the clinician to easily break ampoule 25 and thus allow the anti-microbial solution to flow therefrom.

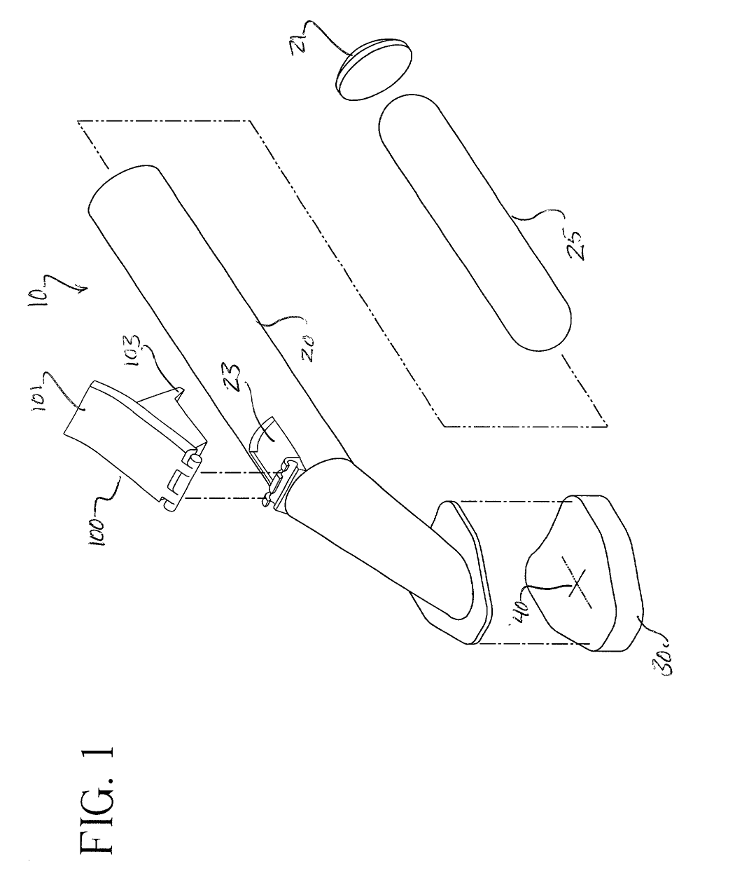

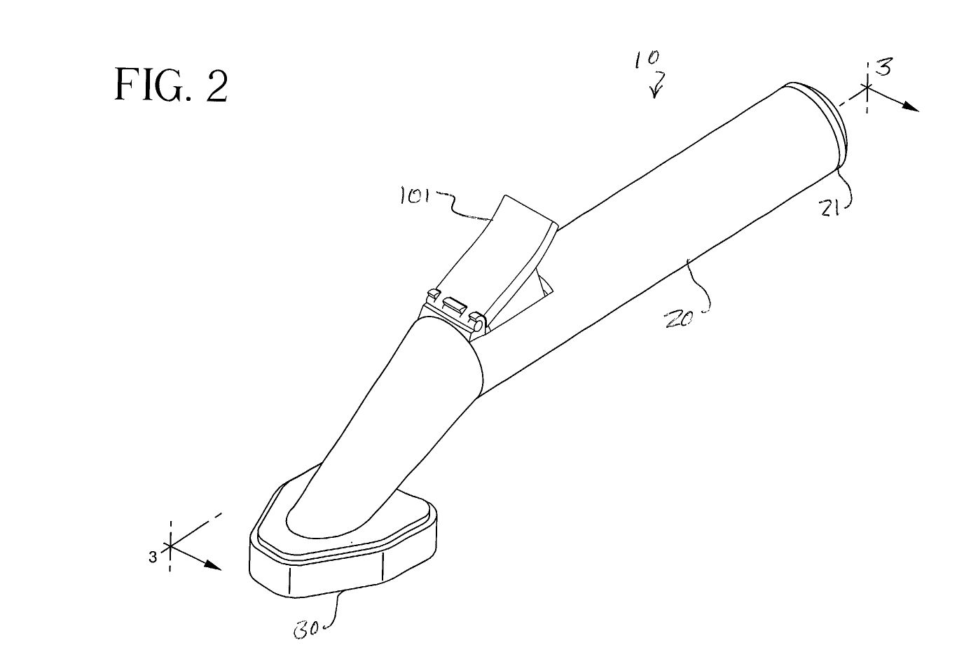

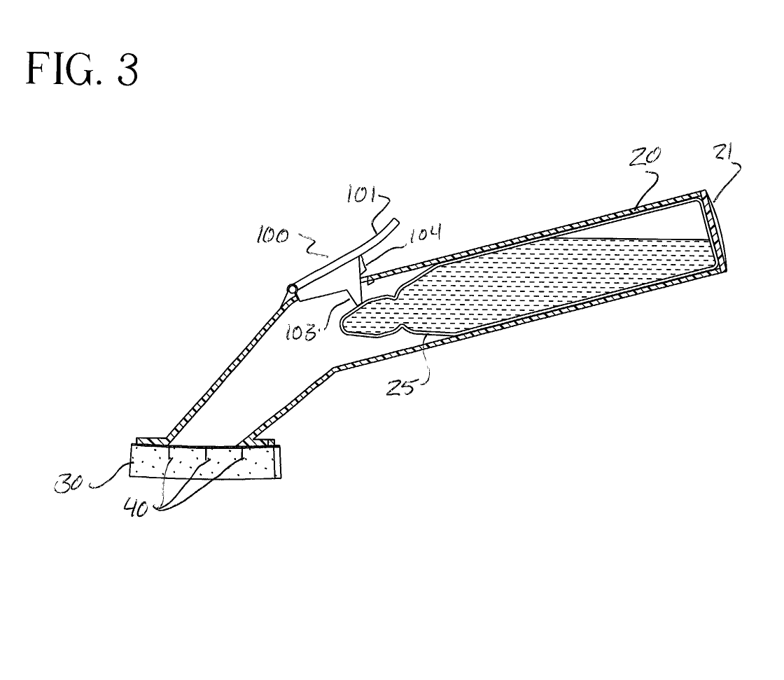

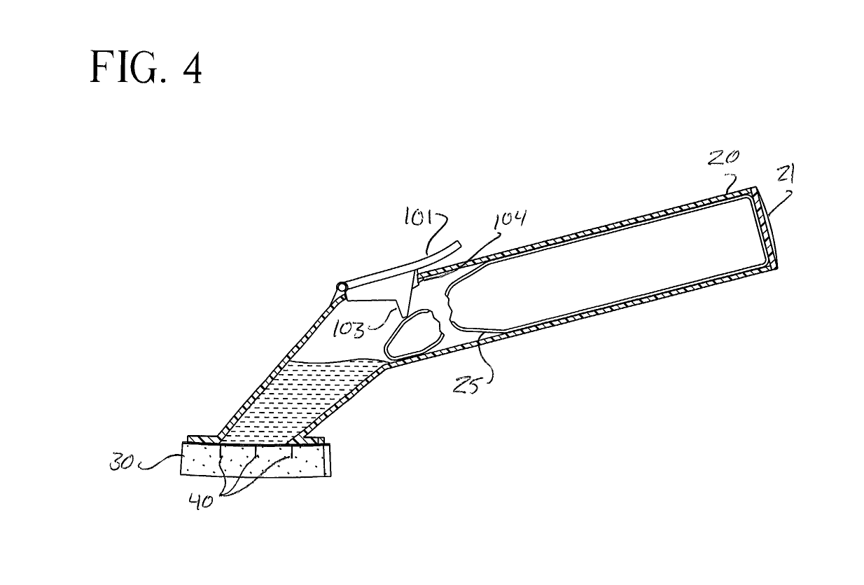

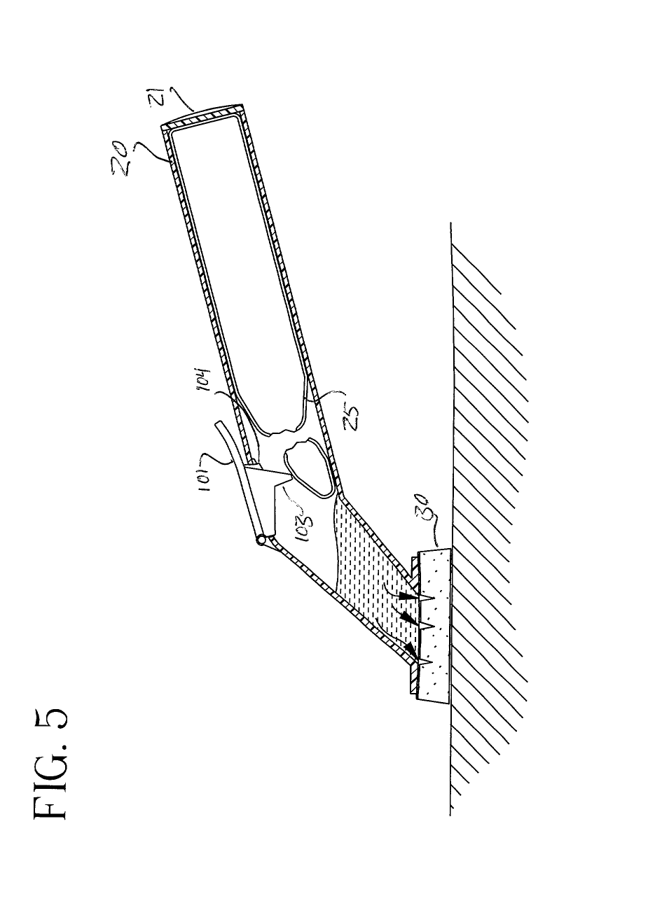

A variety of different means may be used to allow the clinician to break the frangible portion of ampoule 25. For example, a pivoting trigger lever may be used. See FIGS. 1-7. In this embodiment, trigger lever 100 is connected to hollow handle 20 by any appropriate means that allows trigger lever 100 to pivot toward the inside of hollow handle 20. For example, trigger lever 100 could be formed integrally with hollow handle 20 such that trigger lever 100 is connected to hollow handle 20 via a living hinge. Alternatively, trigger lever 100 could be a separate piece that is connected to hollow handle by a pivot pin that allows trigger lever 100 to pivot with respect to hollow handle 20. Trigger lever 100 includes an arm 101 and a pressure finger 103 extending inwardly from arm 101. If desired, a flange 104 may extend inwardly from arm 101. This flange 104 is designed to engage hollow handle 20 and prevent inadvertent activation of trigger lever 100 and thus prevent inadvertent opening of ampoule 25.

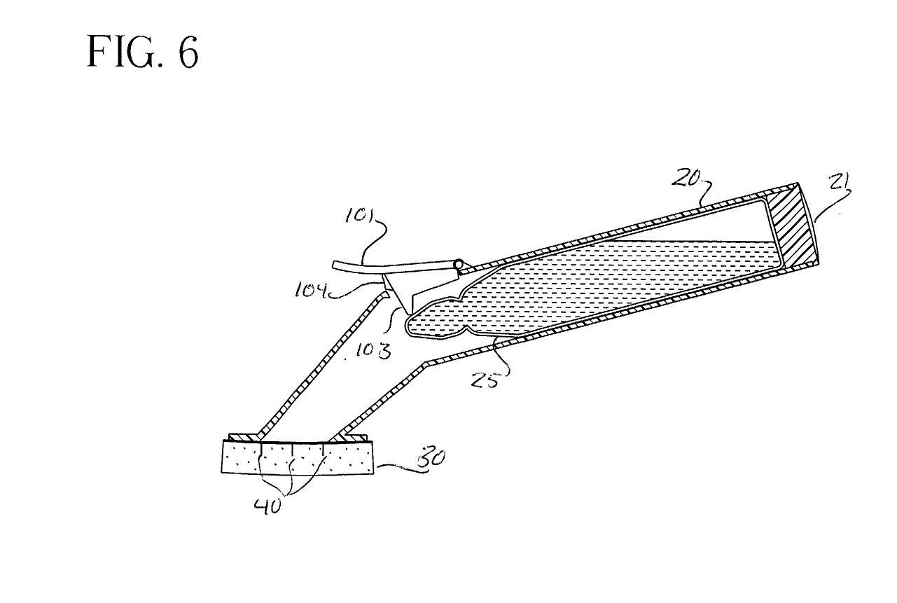

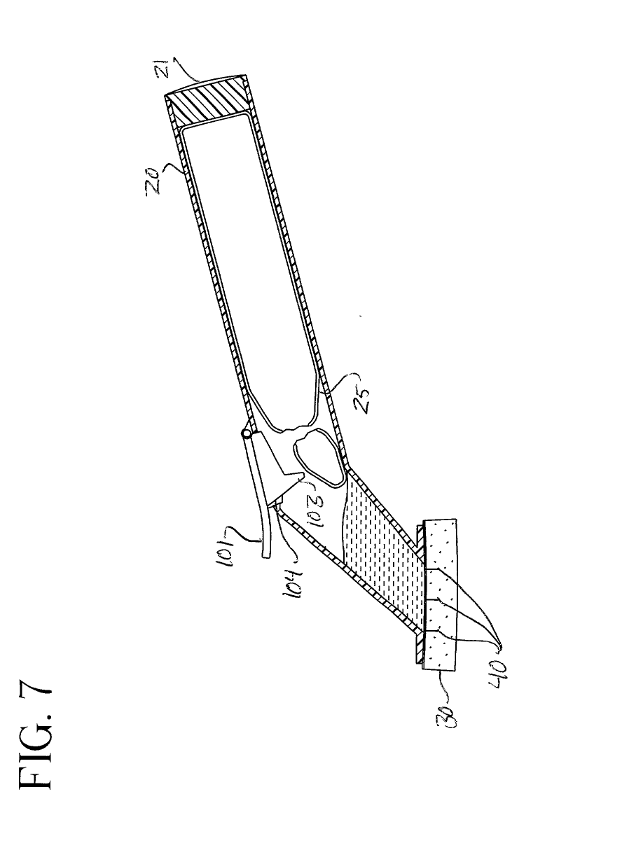

Trigger lever 100 is located adjacent to the angled portion of hollow handle 20 such that pressure finger 103 is adjacent to the frangible portion of ampoule 25. The pivot point for trigger lever 100 can be located distally of trigger lever 100, see FIGS. 1-5 or the pivot point for trigger lever 100 can be located proximally of trigger lever 100, see FIGS. 6-7. Although both of these embodiments disclose the lever at the top of hollow handle 20, it is to be understood that the lever can be located at any circumferential location about hollow handle 20.

Hollow handle 20 has an opening 23 formed therein to allow pressure finger 103 to directly contact the frangible portion of ampoule 25. Thus when arm 101 is pressed inwardly by the clinician, pressure finger 103 will pivot inwardly to contact ampoule 25. The force applied to trigger lever 100 will be transmitted directly to the frangible portion of ampoule 25 and thus break open ampoule 25. Preferably, a pressure finger 103 snap fits into opening 23. This seals trigger lever 100 against hollow handle 20 to prevent any anti-microbial solution from leaking from hollow handle 20. If desired, a gasket can be located around opening 23 to ensure that air or fluid does not leak from hollow handle 20 after ampoule 25 has been opened by trigger lever 100.

Preferably, hollow handle 20 and lever 100 are injection molded from high, medium or low density polyethylene, polypropylene, ABS or other suitable material.

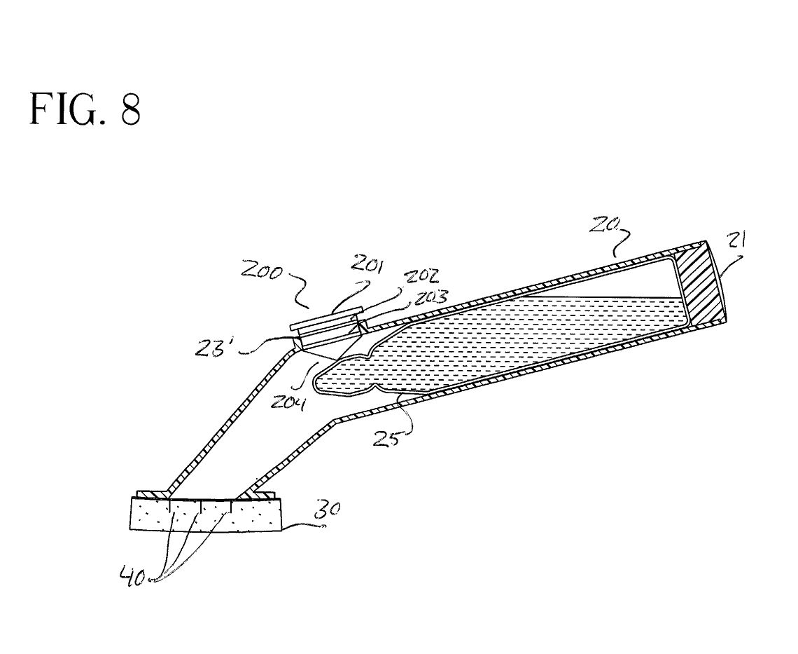

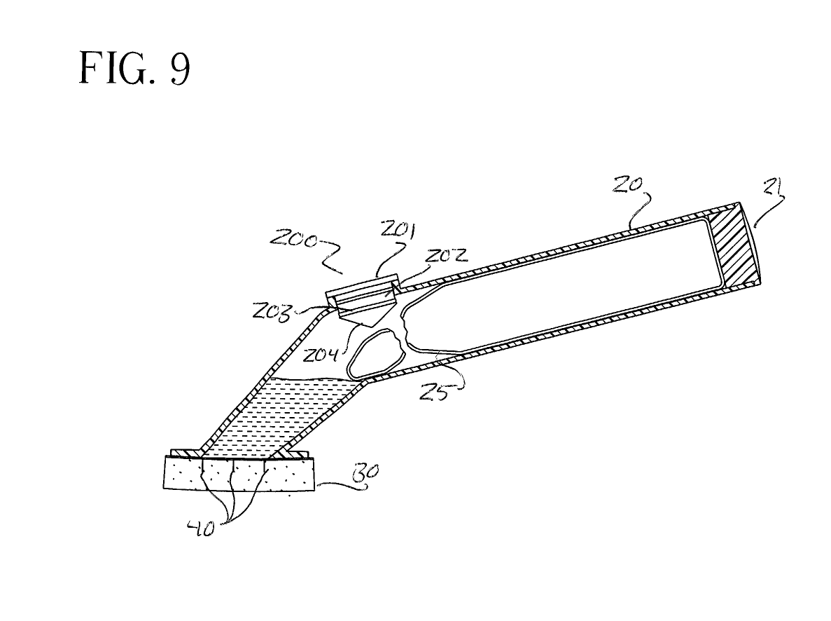

An alternate arrangement may be used as the means to open ampoule 25. See FIGS. 8 and 9. These FIGS. disclose a button arrangement as the means for opening ampoule 25. Button 200 is movably located in an opening 23′ formed in hollow handle 20. Button 200 includes a finger pad 201, a main body portion 202, a central rib 203 and a contact head 204. Central rib 203 is designed to engage hollow handle 20 and prevent inadvertent activation of button 200 and thus prevent inadvertent opening of ampoule 25. In addition, central rib 203 seals opening 23′ when button 200 is located therein. If desired, central rib 203 can be include a gasket to ensure that air or fluid does not leak from hollow handle 20. When a clinician presses button 200, contact head 204 is forced inwardly into contact with ampoule 25. The force applied to finger pad 201 will be transmitted directly to the frangible portion of ampoule 25 and thus break open ampoule 25.

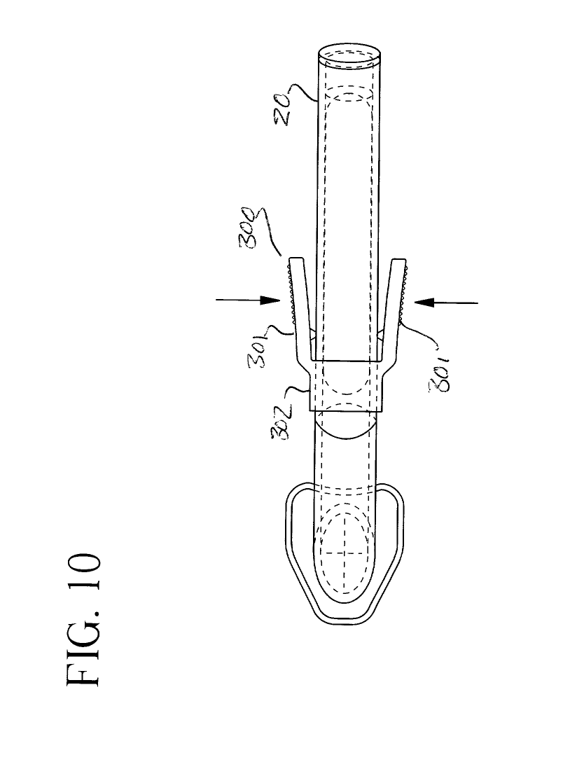

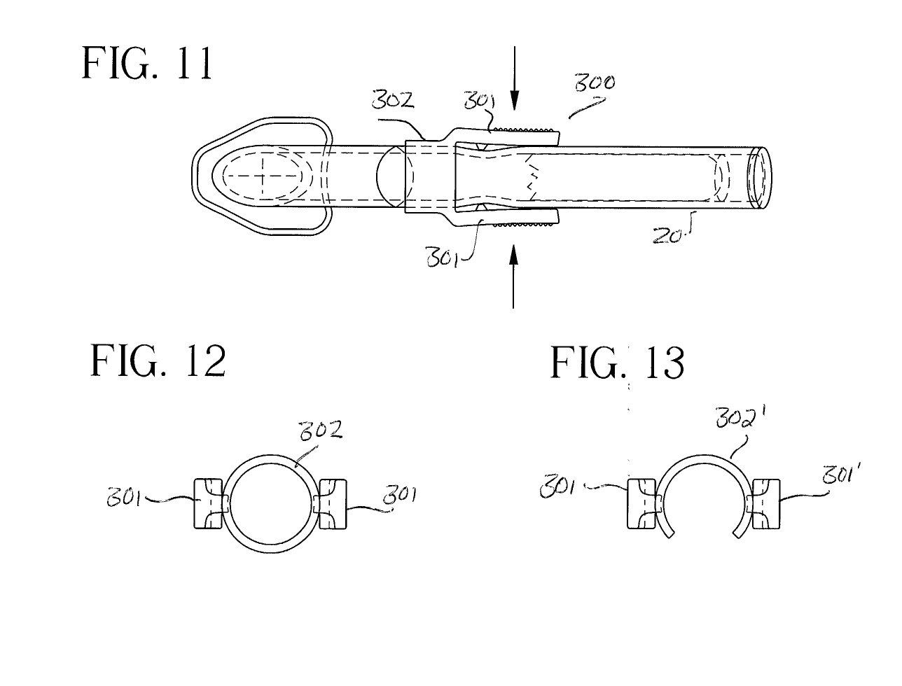

Another lever arrangement is show in FIGS. 10-13. Lever 300 includes at least one arm 301 connected to a collar 302 disposed over hollow handle 20 and a pressure finger 303 connected to each arm 301. Lever 300 is snap fit over hollow handle 20 and is located adjacent to the angled portion of hollow handle 20 such that pressure fingers 303 are adjacent to the frangible portion of ampoule 25. For the convenience of the clinician, preferably two arms 301 located 180 degrees apart are used on lever 300. Arms 301 can be connected to collar 302 in any manner desired that allows arms 301 to pivot with respect to collar 302. Alternatively, arms 301 and pressure fingers 303 can be molded integrally with hollow handle 20. When arms 301 are pivoted toward the inside of hollow handle 20, pressure fingers 303 exert a force onto the frangible portion of ampoule 25 through the wall of hollow handle 20. This breaks ampoule 25 and allows the anti-microbial solution in ampoule 25 to flow toward foam pad 30.

The wall thickness of hollow handle 20 at the point where pressure fingers 303 act on the wall must be sufficiently thin to allow the force applied by pressure fingers 303 to be transmitted to ampoule 25. Conversely, the wall thickness must be sufficiently thick to prevent breakage of hollow handle 20 when the force from pressure fingers 303 is applied to hollow handle 20. Preferably the wall thickness should be about 0.030 inches, although a thickness in the range between about 0.010 inches and about 0.050 inches, depending on the density of the material, would be acceptable. The area adjacent to pressure fingers 303 should have this wall thickness. This area should be substantially rectangular with the major axis parallel to hollow handle 20 and the minor axis extending around a portion of the circumference of hollow handle 20 adjacent to pressure fingers 303. Preferably the major axis is about one inch long and the minor axis is about ½ inch long. This area is formed by molding this area such that the mold's core has a greater diameter in this area or the mold's cavity has a smaller diameter in this area.

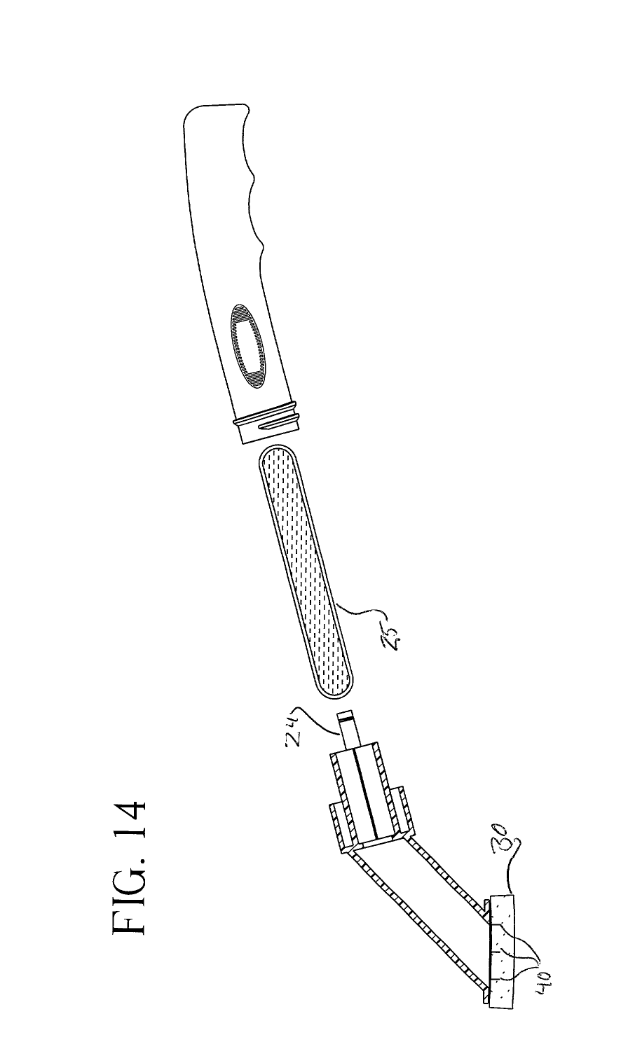

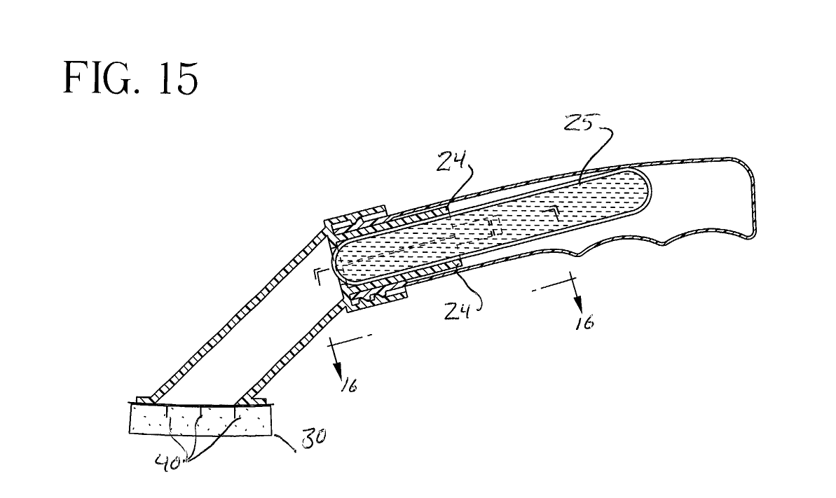

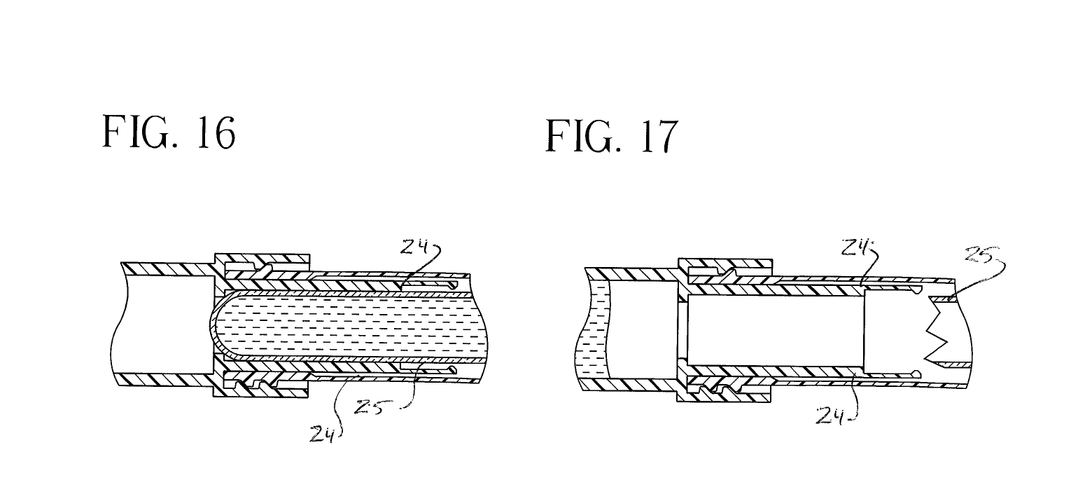

Instead of using a separate external mechanism to open ampoule 25, the means for opening ampoule 25 can be formed internally to hollow handle 20. See FIGS. 14-17. In this embodiment, force is applied by the clinician to a flexible portion of the walls of hollow handle 20. This force is transmitted to an internal rib 24 adjacent to the frangible portion of ampoule 25. This internal rib 24 in turn contacts and breaks ampoule 25. In this embodiment, hollow handle 20 can be blow molded to create any geometry. The thickness can be controlled by the blow molding process. This may be done by controlling the parison's thickness profile prior to molding. Low to medium density blow molding grade polyethylene can be used to provide the appropriate balance between stiffness and flexibility.

In all of the foregoing embodiments, an open cell foam plug or other standard filter can be located between foam pad 30 and the distal end of ampoule 25. The filter may be placed directly on foam pad 30 or along the necked down portion of hollow handle 20. Alternatively, a molded rib located between ampoule 25 and foam pad 30 can be used to hold the filter in place. Such a filter collects any glass shards created when ampoule 25 is broken.

Thus it is seen that an applicator for an anti-microbial solution is provided that is not adversely affected by the sterilization procedure, that protects the anti-microbial solution contained therein from becoming degraded and that allows the clinician to start the flow of the solution therefrom without the need to exert an uncomfortably high force to the applicator.

We claim:

1. An applicator, comprising:
a handle having a closed proximal end, a proximal portion, a distal portion and an open distal end;
an ampoule having a frangible portion disposed in the handle;
a foam pad disposed over the open distal end of the handle; and
a means for opening the ampoule.

2. The applicator of claim 1 further including a filter disposed between the ampoule and the foam pad.

3. The applicator of claim 1 wherein the proximal portion of the handle is at an angle to the distal portion of the handle.

4. The applicator of claim 3 wherein the proximal portion of the handle is oriented at about 15 degrees to the distal portion of the handle.

5. The applicator of claim 4 wherein the foam pad is oriented at about 45 degrees to the distal portion of the handle.

6. An applicator, comprising:
a handle having a closed proximal end, a proximal portion, a distal portion and an open distal end;
an ampoule having a frangible portion disposed in the handle;
a foam pad disposed over the open distal end of the handle; and
a lever disposed on the handle adjacent to the frangible portion of the ampoule wherein the lever is pivotable between a first position where no force is applied to the ampoule and a second position where a force is applied to the ampoule.

7. The applicator of claim 6 wherein the handle defines an opening therein and the lever includes a portion extending through the opening to contact the ampoule.

8. The applicator of claim 7 wherein the lever includes a seal that seals the opening when the lever is in the second position.

9. The applicator of claim 6 wherein the lever includes a pivot point about which the lever pivots.

10. The applicator of claim 9 wherein the pivot point is distal of the lever.

11. The applicator of claim 9 wherein the pivot point is proximal of the lever.

12. An applicator, comprising:
a handle having a closed proximal end, a proximal portion, a distal portion and an open distal end and defining an opening therein;
an ampoule having a frangible portion disposed in the handle;
a foam pad disposed over the open distal end of the handle; and
a button disposed on the handle in the opening adjacent to the frangible portion of the ampoule wherein the button is movable between a first position where no force is applied to the ampoule and a second position where a force is applied to the ampoule.

13. The applicator of claim 12 wherein the button includes a seal that seals the opening when the button is in the second position.

14. An applicator, comprising:
a handle having a closed proximal end, a proximal portion, a distal portion and an open distal end and defining an opening therein;
an ampoule having a frangible portion disposed in the handle;
a foam pad disposed over the open distal end of the handle; and
a rib disposed in the handle adjacent to the frangible portion of the ampoule wherein the handle includes a flexible portion adjacent to the rib such that the flexible portion can be flexed between a first position where no force is applied to the ampoule and a second position where a force is applied to the ampoule.
